(19) United States
(12) Patent Application Publication
(10) Pub. No.: US 2008/0298460 A1
(43) Pub. Date: Dec. 4, 2008

(54) Method and Apparatus for Spatial Scalable Compression of a Video Stream

(75) Inventors: Jin Wang, Shanghai (CN); Gang Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,432

(22) PCT Filed: Jul. 4, 2005
(86) PCT No.: PCT/IB2005/052211

§ 371 Date: Jan. 22, 2007

(30) Foreign Application Priority Data
Jul. 26, 2004 (CN) 200410059069.8

(51) Int. Cl. H04B 1/66

(52) U.S. Cl. 375/240.01; 375/E07.001

(57) ABSTRACT

The invention provides a method of spatial scalable compression of video stream. The video stream is a stream having a resolution higher than a specified resolution. Firstly, the video stream is down-sampled and encoded to obtain a base stream; then the base stream is decoded and up-sampled to obtain a reconstructed stream; the reconstructed stream is subtracted from the video stream to obtain a residual stream; and next, a gain value is obtained according to an expected bitrate; in the end, the gain value is multiplied by the residual stream, the result obtained thereby is encoded to obtain an enhancement stream. The invention can not only determine the gain value according to the video stream itself, but also adjust the gain value dynamically according to external application environments, thus enabling the bitrate of the enhancement stream to meet the actual demand always.

### BACKGROUND OF THE INVENTION

The invention relates to a video stream compression method and an apparatus therefor, and particularly, relates to a video stream compression method and apparatus adopting spatial scalable compression scheme.

Because of the massive amount of data contained in digital video, the transmission of high resolution video signal is a big problem in producing high resolution TV program. Further more, each frame of digital picture is a still picture formed of a group of pixels, and the number of the pixels is determined by the display definition of a specified system. Therefore, the amount of original digital information in high resolution video is massive. In order to reduce the amount of data to be transmitted, a plurality of compression schemes have been brought forward, including MPEG-2, MPEG-4, H.263 and various video compression standards or procedures.

In many applications, video is available at various resolutions/qualities in one stream. Methods achieving this technique are referred to as spatial scalable techniques, or layered techniques. In this type of techniques, the bitstream can be divided into two or more bitstream layers that have different resolutions, and these bitstream layers can be combined into single high resolution signal. For example, a bitstream is divided into two bitstream layers, i.e. a base layer and an enhancement layer, and the base layer can provide a video signal having lower quality and lower resolution, while the enhancement layer can provide additional information to enhance the base layer picture.

In practice, scalable can be performed on three axes. The first is on spatial axis, called spatial scalable; the second is on quality axis, called SNR scalable or fine scalable; the third is on time axis, called temporal scalable. Most of the video compression standards support these scalable techniques, e.g. MPEG-2, MPEG-4, H.263 and the like.

FIG. 1 illustrates a known video encoder that supports the spatial scalable compression scheme. This technical solution is disclosed in the international application document under publication number WO03/036979A1 (international filling date: Oct. 16, 2002). The content disclosed by this application is inserted herein.

A high resolution video stream is sent to a low pass filter 112 to be down-sampled, and then the down-sampled stream is encoded by encoder 116 to obtain a base stream.

The base stream is decoded and sent to an up-sampling unit 122 to be up-sampled to obtain a reconstructed stream. The reconstructed stream and the high resolution video stream are then passed together to a subtraction unit 132, the subtraction unit 132 subtracts the reconstructed video stream from the high resolution video stream to obtain a residual stream.

The high resolution video stream is further sent to a picture analyzer 142, which analyzes each pixel of the video stream to obtain a gain value, which tends towards zero in picture areas with less details and towards one in picture areas with more details.

The gain values and the residual stream are sent to a multiplier 152 together, after multiplied with each other, the pixel value of a pixel in the picture area with less details becomes smaller. Thus, the length of binary bits representing the pixel value becomes shorter, so that the result of the multiplication comprises smaller amount of data than the original residual stream. The result of multiplying the two is further sent to an encoder 156 to be encoded, thus obtaining an enhancement stream.

The existing SNR(signal-noise Ratio) scalable compression scheme uses a similar method, that is, a gain value is obtained by picture analyzing each pixel, and then these gain values are used to adjust the bitrate of residual stream, thus obtaining an enhancement stream.

However, in the existing spatial compression schemes, the adjustment of the gain value of residual stream bitrate is determined only by the content of video itself, without considering the restrictive condition of certain specific application environments of compressed bitstream, e.g. service quality of transmission network and storage space. Therefore, when there are some changes in the external network condition or storage space, the existing compression schemes cannot be adjusted timely, thus making the output bitrate unable to meet the actual demand. Therefore, a new video spatial scalable compression scheme, which could be adjusted timely according to changes in application environments of compressed bitstream, is need, thus adapting the compressed bitrate to external changes.

### OBJECT AND SUMMARY OF THE INVENTION

The invention is an improvement to the above technical solution. It adjusts the process of compression timely by analyzing the application environments of the compressed video stream, so as to achieve a desired compression effect.

The invention provides a method of spatial scalable compression of video stream. The video stream is a stream having a resolution higher than a specified resolution. Firstly, download-sampling the video stream and encoding the video stream to obtain a base stream; then decoding the base stream and up-sampling the base stream to obtain a reconstructed stream; subtracting the reconstructed stream from the video stream to obtain a residual stream; and subsequently, obtaining a gain value according to an expected bitrate; in the end, multiplying the gain value with the residual stream, and encoding the result obtained thereby to obtain an enhancement stream having said bitrate.

One embodiment of the invention is to obtain the expected bitrate according to the service quality of a transmission network. The transmission network transmits said spatial scalable compressed video stream. In this case, the bitrate of the compressed video stream will be dynamically adjusted according to the changes of the network service quality, thus ensuring that the receiving end can receive video stream as good as possible without having a mass of packet loss.

Another embodiment of the invention is to obtain the expected bitrate according to an expected storage space. In this case, users can store the video stream in a suitable storage space as desired.

Still another embodiment of the invention is to conduct picture analysis to a stream whose resolution is higher than a specified resolution to obtain another gain value, and make use of said first gain value and said another gain value to process said residual stream, thereby obtain an enhancement stream having said bitrate. In this case, through analyzing the actual application of the video stream, the bitrate of the enhancement stream can be dynamically adjusted in real time based not only on the internal condition of the video stream, but also on its external application environments, such that the bitrate in the enhancement stream can dynamically meet the actual demand.

The invention further provides an apparatus for spatial scalable compression of video stream. The video stream is a stream having a resolution higher than a specified resolution. The apparatus comprises: a reconstructed stream generating means for processing the video stream to obtain a reconstructed stream, and the reconstructed stream is a stream having resolution higher than a specified resolution; a residual stream obtaining means for comparing the video stream with the reconstructed stream to obtain a residual stream, and the residual stream is a stream having resolution higher than a specified resolution; a bitrate gain value obtaining means for obtaining a gain value according to an expected bitrate; and an enhancement stream generating means for processing the residual stream with the gain value to obtain an enhancement stream having said bitrate. Wherein the expected bitrate is obtained depending on the service quality of the transmission network. The transmission network transmits the spatial scalable compressed video stream. In addition, the expected bitrate can also be determined by an expected storage space.

The invention also provides a digital recorder, which comprises: a receiver, for receiving a video stream, the video stream is a stream having a resolution higher than a specified resolution; a storage unit, for storing the compressed video stream on the storage medium; a retrieving unit, for retrieving the video stream from the storage medium; and an apparatus for spatial scalable compression of video stream as described above, for spatial scalable compressing the video stream to obtain a base stream and an enhancement stream having the expected bitrate.

Other objects and achievements of the invention will be obvious and a more complete understanding can be acquired by referring to the claims and the following description in conjunction with the accompanying drawings.

### BRIEF DESCRIPTION OF THE DRAWINGS

The invention is hereby described in detail[, by way of embodiment, with reference to the accompanying drawings, wherein:

FIG. 1 illustrates an existing video encoder adopting spatial scalable compression scheme;

FIG. 2 is a schematic diagram of an encoding system that implements spatial scalable compression according to an expected bitrate based on one embodiment of the invention;

FIG. 3 is a flow diagram of spatial scalable compression according to an expected bitrate based on one embodiment of the invention;

FIG. 4 is a flow diagram of adjusting the gain value according to an expected bitrate based on one embodiment of the invention;

FIG. 5 is flow diagram of adjusting the gain value according to an expected bitrate based on another embodiment of the invention;

FIG. 6 illustrates a digital recorder according to still another embodiment of the invention.

In all the drawings, the same reference numbers indicate similar or identical features and functions.

### DETAILED DESCRIPTION OF THE INVENTION

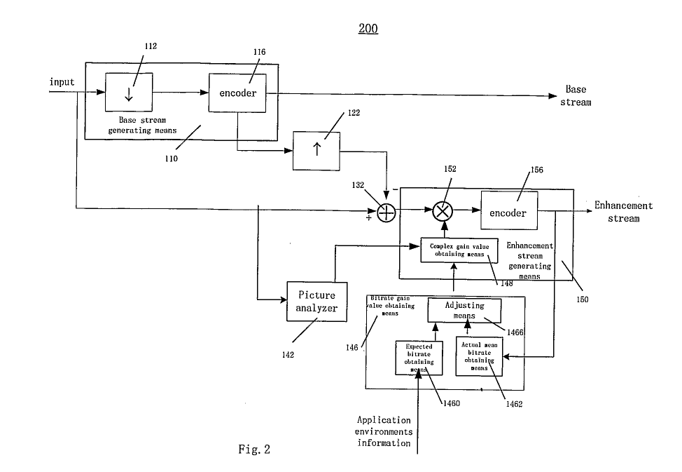

FIG. 2 is a schematic diagram of an encoding system that implements spatial scalable compression according to an expected bitrate based on one embodiment of the invention. The encoding system 200 comprises a base stream generating means 110, for down-sampling a high resolution video stream and then encoding it to obtain a base stream, which is a low resolution stream; a reconstructed stream obtaining means 122, for decoding and up-sampling the base stream to obtain a reconstructed stream, which is a high resolution stream; a residual stream obtaining means 132, for comparing said video stream with the reconstructed stream to obtain a residual stream, which is a high resolution stream; a bitrate gain value obtaining means 146, for obtaining a gain value α₂ according to an expected bitrate; and an enhancement stream generating means 150, for multiplying the gain value with said residual stream, and encoding the result to obtain an enhancement stream.

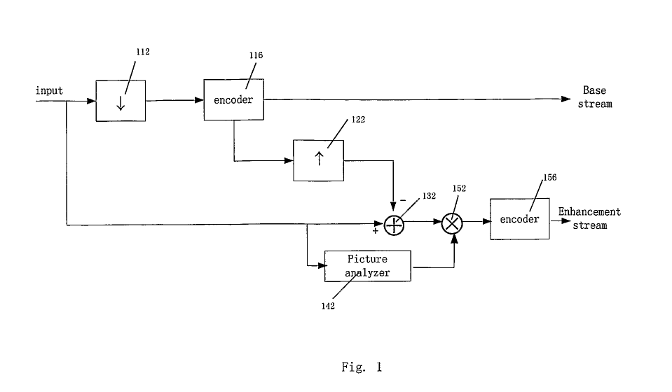

The base stream generating means 110 comprises a low pass filter 112 and an encoder 116. The low pass filter 112 down-samples the video stream to reduce its resolution; the encoder 116 encodes the down-sampled stream to obtain a base stream. The low pass filter 112 and the encoder 116 have the same or similar features and functions as the means indicated by identical reference numbers in FIG. 1.

The reconstructed stream obtaining means 122 is a up-sampling unit 122 with a decoder (not shown in the drawings), which decodes the base stream. This decoding process can also be implemented by the encoder 116 while it is encoding (referred to as local decoding), or can be implemented by a separate decoder (not shown in the drawings). The base stream generating means 110 and the reconstructed stream obtaining means 122 can be combined into a reconstructed stream generating means.

The enhancement stream generating means 150 comprises a multiplier 152 and an encoder 156. The multiplier 152 processes the residual stream with said gain value; the encoder 156 encodes the result output from the multiplier to obtain an enhancement stream. The multiplier 152 and the encoder 156 have the same or similar features and functions as the means indicated by identical reference numbers in FIG. 1.

The bitrate gain value obtaining means 146 comprises an expected bitrate obtaining means 1460, for obtaining an expected bitrate according to the application environments of the compressed stream, wherein the expected bitrate is the maximum bitrate achievable by the compressed video stream and allowable in the application environments; the application environments information comprises the expected storage space or service quality of the transmission network; an actual mean bitrate obtaining means 1462, for obtaining the actual mean bitrate depending on parameters of encoder 156; an adjusting means 1466, for determining whether the actual mean bitrate of the enhancement layer is larger than the current allowed bitrate, so as to determine whether the gain value needs to be varied; and if the actual mean bitrate is larger than the allowed bitrate, then the gain value is reduced to make the bitrate of the enhancement layer smaller than the allowed bitrate; if the actual mean bitrate is smaller than the allowed bitrate, then the gain value is increased to make the bitrate of the enhancement layer larger.

The encoding system 200 can also selectively comprise a picture analyzer 142, for analyzing pixels of the high resolution stream to obtain a gain value α₁ of each pixel of the high resolution stream. In this case, the enhancement stream generating means 150 further comprises a complex gain value obtaining means 148, for processing α₁ and α₂ to obtain a complex gain value a, and the enhancement stream generating means 150 multiplies said complex gain value with said residual stream, and then encodes the result to obtain an enhancement stream.

The functions of apparatus 200 or part of its means can be implemented through software. To those ordinarily skilled in the art, the above means included in apparatus 200 can be realized through various existing means, by just combining them together to achieve said functions of the invention.

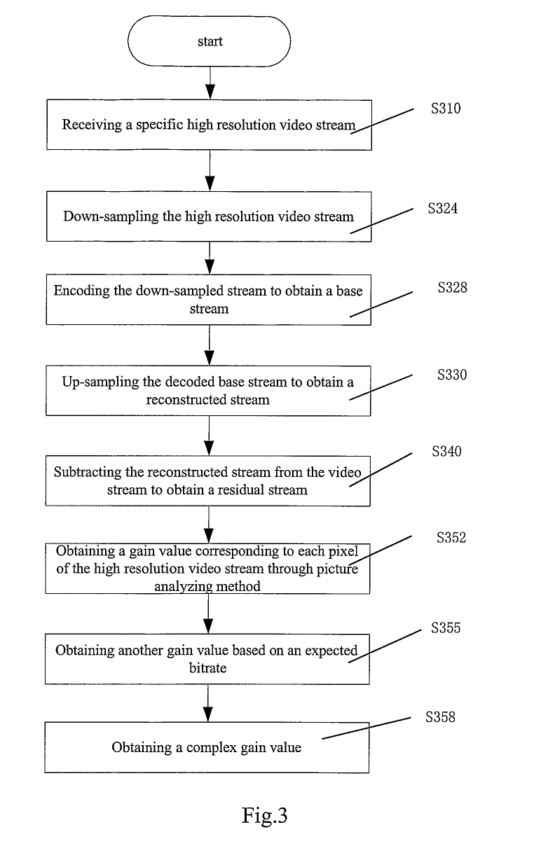

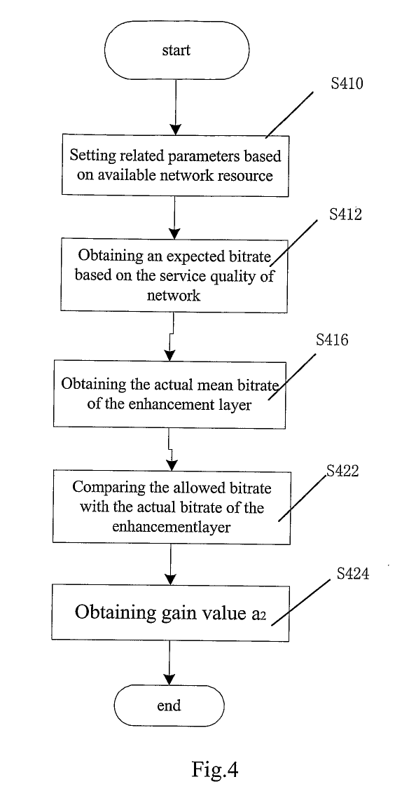

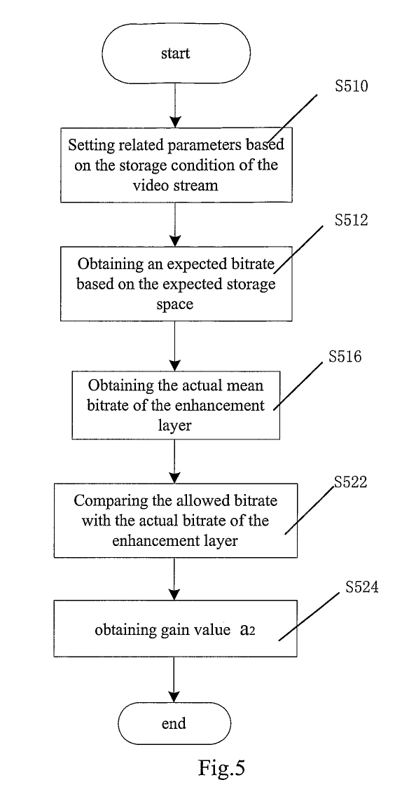

The operation flow of apparatus 200 is shown in FIG. 3 below, wherein the operation flow of bitrate gain value obtaining means 146 is shown in FIGS. 4 and 5.

FIG. 3 is a flow diagram of spatial scalable compression according to an expected bitrate based on one embodiment of the invention.

Firstly, a specific high resolution video stream (step S310), such as a video stream having resolution of 1920×1080 i is received, the high resolution may be larger than a specified resolution; and the high resolution video stream is down-sampled (step S324). The purpose of down-sampling the video stream is to reduce its resolution, e.g. to 720×480 i. Then, the down-sampled stream is encoded to obtain a base stream (step S328), wherein the encoding can be implemented according to MPEG-2 standards. The base stream is a low resolution stream, e.g. 720×480 i.

Secondly, the decoded base stream is up-sampled to obtain a reconstructed stream (step S330). The reconstructed stream has substantially the same resolution format as that of the received high resolution video stream, e.g. 1920×1080 i. Then, the reconstructed stream is subtracted from the received high resolution video stream to obtain a residual stream (step S340). The residual stream has substantially the same resolution format as that of the received high resolution video stream, e.g. 1920×1080 i.

Next, the gain value α₁ corresponding to each pixel of the high resolution video stream is obtained through a picture analyzing method (step S352). This step can use known method. Of cause, the picture analysis of said reconstructed stream or residual stream can also be made to obtain the corresponding gain value α₁.

Then, a gain value α₂ is obtained based on an expected bitrate (step S355). The expected bitrate is determined by the application environments of the compressed video stream, e.g. the service quality of the transmission network for transmitting the video stream, or storage space for storing the video stream. The details of the operation for obtaining α₂ are shown in FIGS. 4 and 5 below.

According to the gain value α₁ determined by the above picture analysis and the gain value α₂ determined by the expected bitrate, a complex gain value α is obtained (step S358). For example, α=λα₁+μα₂, wherein λ and μ are weighting factors, which satisfy λ=1−μ, 0≦λ, μ≦1, the weighting factors can be determined by the requirements of the system .

In the end, each pixel in the residual stream is multiplied by its corresponding gain value, then the result thereof is encoded to obtain an enhancement stream (step S370).

In this embodiment, a complex gain value is obtained based on α₁ and α₂, and the residual stream is adjusted based on the complex gain value. Certainly, those ordinarily skilled in the art should know well that this procedure can omit step S352 to adjust the residual stream directly with α₂ alone to obtain an enhancement stream bitrate that matches the network service quality, e.g. when the video stream is mainly influenced by external environments such as the service quality of the network.

FIG. 4 is a flow diagram of adjusting the gain value according to an expected bitrate based on one embodiment of the invention. The expected bitrate in the embodiment is determined by the transmission network of the compressed video stream. Usually, the service quality of the transmission network fluctuates dynamically, so the allowed bitrate of the transmission network fluctuates too. In this way, it is hard to ensure the transmission quality of a video stream with constant bitrate. This procedure can solve this problem.

Firstly, before a stream session starts, correlative parameters are set according to available resources (step S410). For example, if initially allowed network bandwidth is B₀=20 Mbps, the bitrate of the base layer can be set to 5 Mbps, and the bitrate of the enhancement layer can be set to 15 Mbps. The allowed network bandwidth can be obtained through detection, while the bitrate setup can be accomplished by setting encoders 115 and 156 in FIG. 2 only one time. The dynamic ranges (αₘᵢₙ, αₘₐₓ) of gain values α₁ and α₂ are both (0, 0.5), here, α₁=0.5, α₂=0.5. The adjusting range of α₂ can be set to Δα=(αₘₐₓ−αₘᵢₙ)/10=0.05. Certainly, it can be set more precisely according to circumstances.

Secondly, an expected bitrate is obtained according to the network service quality (step S412). The network service quality is obtained by detecting the network conditions, such as the bandwidth of the network and the processing capacity of the network, during the transmission of the video stream, so as to obtain a bitrate, which corresponds to current network service quality and the network allows to receive, i.e. an expected bitrate, e.g. 15 Mbps. The expected bitrate indicates that the current network service quality is worse than the initial network service quality. Because the bitrate of the base layer is constantly 5 Mbps, the allowed bitrate of the enhancement layer is reduced to 10 Mbps. The detection of the network conditions can be performed at particular frequency as desired.

At the same time, an actual bitrate of the enhancement layer is obtained (step S416). The actual bitrate of the enhancement layer can be obtained through parameters of the encoder 156, e.g. the current actual bitrate of the enhancement layer is 12 Mbps.

Next, the allowed bitrate of the enhancement layer is compared with the actual bitrate (step S422). As described above, the current allowed bitrate of the enhancement layer is 10 Mbps, the actual bitrate of the enhancement layer is 12 Mbps. Therefore, the current actual bitrate of the enhancement layer has exceeded the allowed bitrate. If the enhancement layer continues to compress and transmit at this bitrate in current transmission network, problems such as network jam and transmission quality deterioration are sure to arise. Therefore, α₂ needs to be adjusted to reduce the output bitrate of the enhancement layer until it is smaller than the allowed bitrate.

In the end, the gain value α₂ is adjusted and obtained according to the above comparison result (step S424). Here the procedure of adjusting α₂ is a cyclic process with continuous comparisons and fine adjustments, the details of which are described as follows:

During the first procedure, the current actual bitrate of the enhancement layer has exceeded the allowed bitrate. On the basis of the adjusting range Δα=0.05, making α′₂=α₂−Δα=0.5−0.05=0.45, then processing the residual stream through α=α₁+α′₂=0.5+0.45=0.95, and obtaining a smaller actual bitrate of the enhancement layer based on the parameters of encoder 156;

During the second procedure, the smaller actual bitrate of the enhancement layer obtained above is compared with the allowed bitrate. If this bitrate of the enhancement layer is still larger than the allowed bitrate, then making α″₂=α′₂−Δα=0.45−0.05=0.4, processing the residual stream through α=α₁+α″₂=0.5+0.4=0.9, and obtaining a still smaller actual bitrate of the enhancement layer based on the parameters of encoder 156; . . .

This cycle continues until the actual bitrate of the enhancement layer obtained from encoder 156 is smaller than the allowed bitrate of the enhancement layer. For example, when α 2 is reduced to 0.1, namely the complex gain α is 0.6, then the residual stream is processed by said α, and the actual bitrate of the enhancement layer obtained according to the parameters of encoder 156 is 9 Mbps, thus making the current output bitrate of the enhancement layer meet the actual conditions of the network.

The fine adjustment mentioned above is accomplished in quite a short time, so in the above embodiment, α 1 is assumed to be constant. In the actual compression procedure, α 1 will vary according to the condition of the picture. Therefore, it will be fine as long as the mean value of the actual bitrate of the enhancement layer is smaller than or equal to the allowed bitrate of the enhancement layer.

As described above, if the network bandwidth is detected wider and there is no jam in the network, then α 2 can take a larger value to make the enhancement layer maintain more information; if the network is detected to be quite crowded, then α 2 can take a smaller value to make the bitrate of the enhancement layer smaller and the information carried thereby less, thus partly discarding the information on this layer.

Steps S412, S416, S422, S424 can be performed repeatedly until the transmission of the video stream ends, thus dynamically compressing the video stream during the whole transmission procedure to adapt to changes in the network.

FIG. 5 is flow diagram of adjusting the gain value according to an expected bitrate based on another embodiment of the invention. In this embodiment, the expected bitrate is obtained based on the storage condition of the video stream. For example, this storage condition could be the residual storage space of the storage medium of the video stream. Since the residual storage space varies at all times during the storage procedure of video stream, the allowed bitrate of the compressed video stream determined by the residual space and the storage time also varies continuously. Therefore, if the video stream is stored at constant bitrate, the storage space will probably be insufficient and result in storage failure. The procedure can solve said technical problem.

Firstly, related parameters are set according to the storage condition of the video stream (step S510). For example, an audiovisual program is to be stored on a one-surface two-layer DVD+RW optical disk. The capacity of the optical disk is 8.5 GB (i.e. 68000 Mbits), which records only one track, the bitrate is 384 kbps, the bitrate of the SD base layer is 4.5 Mbps, the maximum recording time T is 90 mins, and the dynamic ranges (αₘᵢₙ, αₘₐₓ) of the gain values α₁,α₂ are both (0, 0.5). At this moment, α₁=0.5, α₂=0.5. The adjusting range of α₂ can be set as Δα=(αₘₐₓ−αₘᵢₙ)/10=0.05. Certainly, it can be set more precisely according to circumstances.

Secondly, an expected bitrate is obtained based on current residual storage space (step S512). A current allowed bitrate of the enhancement layer, i.e. an expected bitrate, can be obtained according to the current residual space of the DVD optical disk. At the moment t during the storage procedure of video stream, the allowed bitrate of the enhancement layer is:

$${b}_{enh} = \frac{68000 - ( 0.384 \times t )}{t} - 4.5 = \frac{68000}{t} - 4.884 Mbits \text{/} s$$

wherein, bₑₙₕ is bitrate of the enhancement layer, t is the recording time.

According to the above formula, when t=75 mins, namely in the 75th min of the storage procedure, the allowed bitrate of the enhancement layer is about 10 Mbps. This obtaining procedure can proceed at certain frequency as desired.

Then, the actual bitrate of the enhancement layer is obtained (step S516). The actual bitrate of the enhancement layer can be obtained based on the parameters of encoder 156, e.g. the current actual bitrate of the enhancement layer is 12 Mbps.

Next, the allowed bitrate of the enhancement layer is compared with the actual bitrate (step S522). As obtained from the above procedure, the current allowed bitrate of the enhancement layer is 10 Mbps, and the actual bitrate of the enhancement layer is 12 Mbps. Therefore, the current actual bitrate of the enhancement layer has exceeded the allowed bitrate. If the enhancement layer continues to compress and store at this bitrate, the current storage space will not be able to store the whole video within specified time (90 mins). Therefore, α₂ needs to be adjusted to reduce the output bitrate of the enhancement layer until it is smaller than or equal to the allowed bitrate.

In the end, the gain value α₂ is adjusted and obtained according to the above comparison result (step S524). Here the procedure of adjustingα₂ is a cyclic process with continuous comparisons and fine adjustments, the details of which are described as follows:

During the first procedure, the current actual bitrate of the enhancement layer has exceeded the allowed bitrate. On the basis of the adjusting range Δαa=0.05, making α′₂=α₂−Δα=0.5−0.05=0.45, then processing the residual stream through α=α₁+α′₂=0.5+0.45=0.95, and obtaining a smaller actual bitrate of the enhancement layer based on the parameters of encoder 156;

During the second procedure, the smaller actual bitrate of the enhancement layer obtained above is compared with the allowed bitrate. If this bitrate of the enhancement layer is still larger than the allowed bitrate, then making α″₂=α′₂−Δα=0.45−0.05=0.4, processing the residual stream through α=α₁+α″₂=0.5+0.4=0.9, and obtaining a still smaller actual bitrate of the enhancement layer based on the parameters of encoder 156; . . .

This cycle continues until the actual bitrate of the enhancement layer obtained from encoder 156 is smaller than the allowed bitrate of the enhancement layer. For example, when α 2 is reduced to 0.1, namely the complex gain α is 0.6, then the residual stream is processed by said α, and the bitrate of the enhancement layer obtained according to the parameters of encoder 156 is 9 Mbps, thus making the current output bitrate of the enhancement layer satisfy the current residual storage space.

The fine adjustment mentioned above is accomplished in quite a short time, so in the above embodiment, α₁ is assumed to be constant. In the actual compression procedure, α₁ will vary according to the condition of the picture. Therefore, it will be fine as long as the mean value of the actual bitrate of the enhancement layer is smaller than or equal to the allowed bitrate of the enhancement layer.

As described above, by dynamically monitoring the residual storage space of a DVD optical disk, once the actual bitrate of the enhancement layer exceeds the allowed mean bitrate, then α 2 is reduced to make the bitrate of the enhancement layer smaller, thereby the whole video stream to be stored can be stored in the DVD optical disk and the storage space will not be insufficient.

Steps S512, S516, S522, S524 can be performed repeatedly until the storage of the video stream ends, thus dynamically compressing the video stream during the whole storage procedure to adapt to changes in residual storage space.

Certainly, the storage medium also can be other similar storage medium besides the DVD+RW optical disk described above, such as HD and so on. In addition, the expected storage space can be set according to the will of users. For example, if users want to store an audiovisual program of 30 Mbits, then a digital recorder or other apparatus with storing function can allow users to select the expected space for storing the audiovisual program before the storage starts. For example: a selecting range of 18M-30M can be provided. If a user selects 20 Mbits, then the program can be compressed and stored as a program of 20 Mbits under the control of procedures similar to those described above.

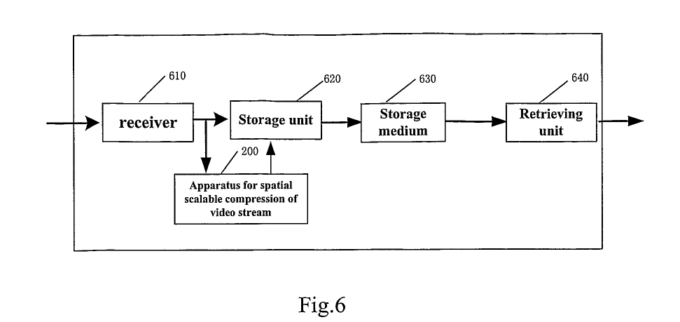

FIG. 6 illustrates a digital recorder according to still another embodiment of the invention. The digital recorder 600 comprises a receiver 610, for receiving a high resolution video stream, e.g. a video stream having resolution of 1920×1080 i. The digital recorder 600 comprises a storage unit 620, for storing the encoded and compressed video stream on storage medium 630. The storage medium 630 is a hard disk, but can also be other suitable medium, such as DVD+RW and etc. The digital recorder 600 further comprises a retrieving unit 640, for retrieving the video stream from the storage medium 630. The retrieving unit 640 replays the programs stored by the recorder or storage unit 620.

The digital recorder 600 further comprises an apparatus for spatial scalable compression of video stream 200 as shown in FIG. 2. The apparatus for spatial scalable compression of video stream 200 receives the high resolution video stream from receiver 610 as raw video stream and performs spatial scalable compression on it, and thereby obtains a base stream and an enhancement stream which have been encoded and compressed. Thereafter, the encoded and compressed video stream is stored on storage medium 630 by storage unit 620. As the apparatus for spatial scalable compression of video stream 200 introduces the gain value α₂, which is related to the expected storage space, the gain value α₂ can be adjusted in real time based on the changes of the storage space, and the residual stream is processed by said gain value. Therefore, the enhancement stream bitrate output from the apparatus for spatial scalable compression of video stream 200 always satisfy the storage space provided by the digital recorder 600.

Although the invention has been described in combination of embodiments, the various substitutes, modification and variations made according to the context above will be apparent to those ordinarily skilled in the art. Thus, the present invention covers the substitutes, modification and variations of this invention when they fall within the spirit and scope of the appended claims.

1. A method of spatial scalable compression of video stream, which is a stream having a resolution higher than a specified resolution, the method comprising:
a. processing the video stream to obtain a reconstructed stream, wherein the reconstructed stream is a stream whose resolution is higher than a specified resolution;
b. comparing the video stream with the reconstructed stream to obtain a residual stream, wherein the residual stream is a stream whose resolution is higher than a specified resolution;
c. obtaining a gain value according to an expected bitrate; and
d. processing the residual stream with said gain value to obtain an enhancement stream having said bitrate.

2. The method according to claim 1, wherein the step a comprises:
down-sampling the video stream and then encoding the sampling to obtain a base stream;
decoding the base stream and up-sampling the base stream to obtain said reconstructed stream.

3. The method according to claim 1, wherein comprises step: obtaining said expected bitrate based on the service quality of a transmission network, and the transmission network transmits said spatial scalable compressed video stream.

4. The method according to claim 3, wherein the service quality of said transmission network is determined by the available network bandwidth of the transmission network.

5. The method according to claim 1, wherein the expected bitrate is determined by an expected storage space.

6. The method according to claim 1, further comprises:
making picture analysis of a said stream whose resolution is higher than a specified resolution to obtain another gain value;
wherein the residual stream processing step comprises a step of using said first gain value and said another gain value to process said residual stream, thereby obtain an enhancement stream having said bitrate.

7. An apparatus for spatial scalable compression of video stream, wherein the video stream is a stream whose resolution is higher than a specified resolution, comprising:
a reconstructed stream generating means, for processing the video stream to obtain a reconstructed stream, the reconstructed stream is a stream whose resolution is higher than a specified resolution;
a residual stream obtaining means, for comparing said video stream with the reconstructed stream to obtain a residual stream, the residual stream is a stream whose resolution is higher than a specified resolution;
a bitrate gain value obtaining means, for obtaining a gain value according to an expected bitrate; and
an enhancement stream generating means, for processing the residual stream with the gain value to obtain an enhancement stream having said bitrate.

8. The apparatus according to claim 7, wherein said expected bitrate is obtained based on the service quality of a transmission network, and the transmission network transmits said spatial scalable compressed video stream.

9. The apparatus according to claim 7, wherein the expected bitrate is determined by an expected storage space.

10. The apparatus according to claim 7, wherein further comprises:
a picture analyzer, for making picture analysis of a said stream whose resolution is higher than a specified resolution to obtain another gain value;
wherein said enhancement stream generating means makes use of said first gain value and said another gain value to process said residual stream, thereby obtain an enhancement stream having expected bitrate.

11. A digital recorder, comprising:
a receiver, for receiving a video stream whose resolution is higher than an expected resolution;
a storage unit, for storing the compressed video stream on a storage medium;
a retrieving unit, for retrieving the video stream from the storage medium; and
an apparatus for spatial scalable compression of video stream as described in claim 7, for spatial scalable compressing the video stream to obtain a base stream and an enhancement stream having expected bitrate.
